(19) United States
(12) Patent Application Publication
(10) Pub. No.: US 2018/0189337 A1
(43) Pub. Date: Jul. 5, 2018

(54) METHOD AND SYSTEM FOR STORING TIME SERIES DATA IN A RELATIONAL DATABASE

(71) Applicant: Teradata US, Inc., Dayton, OH (US)

(72) Inventor: Gregory Howard Milby, San Marcos, CA (US)

(73) Assignee: Teradata US, Inc., Dayton, OH (US)

(21) Appl. No.: 15/396,232

(22) Filed: Dec. 30, 2016

(51) Int. Cl. G06F 17/30

(52) U.S. Cl. CPC G06F 17/30321; G06F 17/30595

(57) ABSTRACT

A system and method for storing time series data in a distributed relational database. A SQL CREATE TABLE statement including a PRIMARY INDEX CLAUSE creates a primary index and associated time series table which organizes time series data records by time, while simultaneously storing the time series data records in an easily queryable time sequential manner

### FIELD OF THE INVENTION

The present invention relates to distributed relational database systems, and more particularly, an improved system and method for storing time series data in a distributed relational database.

### BACKGROUND OF THE INVENTION

The need for new applications in the Internet-of-Things (IOT) application space are driving the need for fast, reliable, scalable Time Series database solutions. Time Series datasets are characterized by a series of records, in which each record has an associated timestamp which identifies the time that is associated with the data in the remainder of the record. The expectation for time series databases is that the records will be organized by time and stored in a time-order-sequence fashion. Such an organization leads itself to enabling time-oriented SQL style queries, such as:
SELECT TS_MEDIAN(TEMPERATURE) FROM OCEAN_BUOYS WHERE RECORD_TIMESTAMP
BETWEEN TIMESTAMP ‘2015-11-22 08:00:00’ AND TIMESTAMP ‘2015-11-22 12:00:00’
GROUP BY TIME(HOURS(1));

SQL User can also GROUP BY other scalar columns, in addition to grouping by time:
SELECT TS_MEDIAN(TEMPERATURE) FROM OCEAN_BUOYS WHERE RECORD_TIMESTAMP
BETWEEN TIMESTAMP ‘2015-11-22 08:00:00’ AND TIMESTAMP ‘2015-11-22 12:00:00’
GROUP BY TIME(HOURS(1) AND BUOYID);

Solving a time-oriented query such as this requires the database to be able to efficiently position by time; and read the targeted data from the input data stream in a sequential time order. This proves difficult for many existing distributed relational databases, because their prime indexes, which typically directly influence the time series data distribution and somewhat influence the storage order; tend to be scalar-oriented indexes. If, for example, the primary index was defined against the RECORD_TIMESTAMP column, then the data corresponding to the time-scope-window of: 8 AM to 12 PM on Nov. 22, 2015, would be scattered across the distributed system. Additionally, it would not be stored in time order. This means that in the relational system, the logic would have to: first, retrieve the rows lying in the time-scope-window; secondly, store those rows in a temporary storage pool; thirdly, sort the intermediate results by their timestamps; and lastly, perform the GROUP BY TIME aggregate operation. The execution of all these substeps in a distributed relational system results in a very inefficient execution of a time series operation. Relational database vendors thus are scrambling to devise an approach for storing time series data in their distributed relational databases, such that they may execute time series oriented operations in an efficient and performant manner

What is needed to solve this dilemma for distributed relational databases is a scheme for creating a primary index and associated time series table, which organizes the time series data set by time, while simultaneously storing the dataset in an easily queryable time sequential manner.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram of an example distributed relational database system.

FIG. 2 is a block diagram of a portion of the example database system of FIG. 1.

FIG. 3 is a block diagram of another portion of the example database system of FIG. 1.

FIG. 4 provides an illustration of a hashing process for distributing records in a table across database modules.

FIG. 5 provides an illustration of a database table row header and row body for a time series table in accordance with the present invention.

FIG. 6 illustrates a method for dividing a time continuum including a time series dataset into a collection of consecutive time segments, in accordance with the present invention.

### DETAILED DESCRIPTION OF THE INVENTION

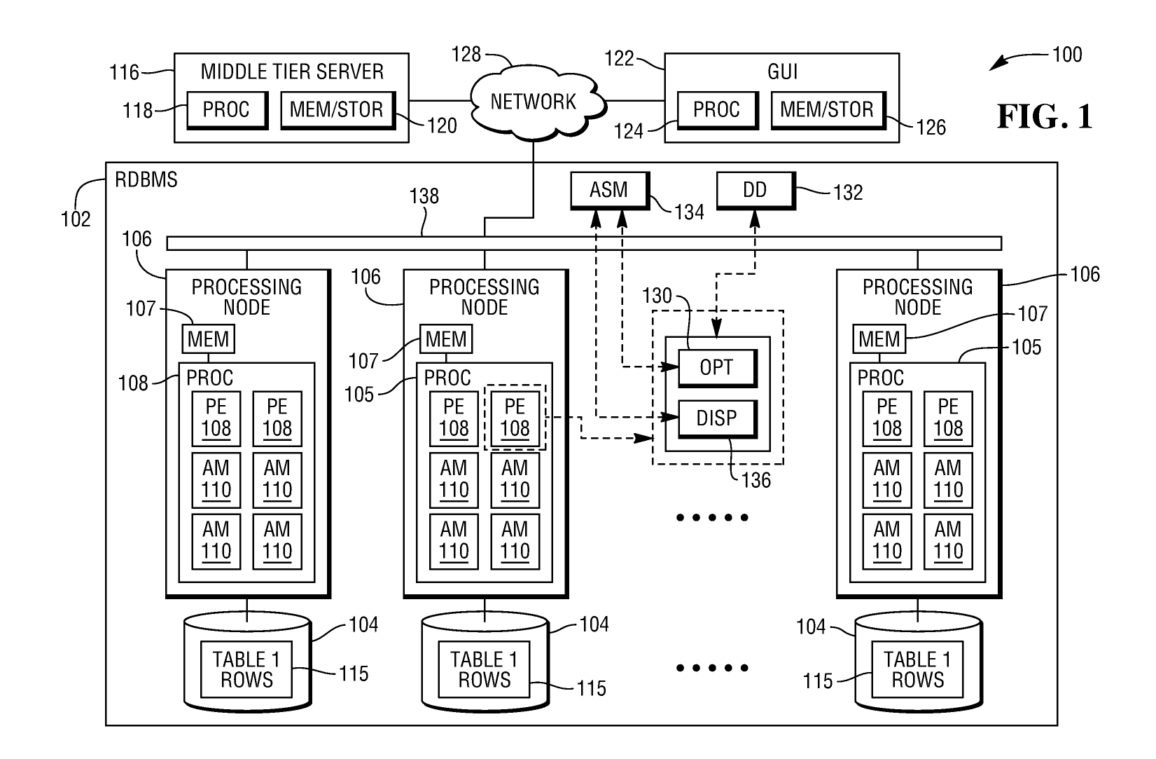

FIG. 1 is a diagrammatic representation of example architecture for a database system 100, such as a Teradata Active Data Warehousing System®. In one example, the database system 100 includes a relational database management system (RDBMS) 102 that implements a parallel-processing environment to carry out database management. The RDBMS 102 may be a combination of software (e.g., computer program routines, subroutines, applications, etc.) and hardware (e.g., processors, memory, etc.). In the example of FIG. 1, the RBDMS 102 may be a massive parallel processing (MPP) system having an array of processing units and distributed memory. In alternative examples, the RBDMS 102 may implement a single processing unit, such as in a symmetric multiprocessing (SMP) system configuration. The RBDMS 102 may include one or more processing units used to manage the storage, retrieval, and manipulation of data in data storage facilities (DSFs) 104. The array of processing units may include an array of processing nodes 106 that manage the storage, retrieval, and manipulation of data included in a database.

In one example, each processing node 106 may include one or more physical processors 105 and memory 107. The memory 107 may include one or more memories and may be computer-readable storage media or memories, such as a cache, buffer, RAM, removable media, hard drive, flash drive or other computer-readable storage media. Computer-readable storage media may include various types of volatile and nonvolatile storage media. Various processing techniques may be implemented by the processors 105 such as multiprocessing, multitasking, parallel processing and the like, for example.

The processing nodes 106 may include one or more other processing unit arrays such as parsing engine (PE) modules 108 and access modules (AM) 110. As described herein, “modules” are defined to include software, hardware or some combination thereof executable by one or more physical and/or virtual processors. Software modules may include instructions stored in the one or more memories that are executable by one or more processors. Hardware modules may include various devices, components, circuits, gates, circuit boards, and the like that are executable, directed, and/or controlled for performance by one or more processors. The access modules 110 may be access modules processors (AMPs), such as those implemented in the Teradata Active Data Warehousing System®.

The parsing engine modules 108 and the access modules 110 may each be virtual processors (vprocs) and/or physical processors. In the case of virtual processors, the parsing engine modules 108 and access modules 110 may be executed by one or more physical processors, such as those that may be included in the processing nodes 106. For example, in FIG. 1, each parsing engine module 108 and access module 110 is associated with a respective processing node 106 and may each be executed as one or more virtual processors by physical processors 107 included in the respective processing node 106.

In FIG. 1, each processing node 106 is shown as including multiple parsing engine modules 108 and access modules 110, such that there are more parsing engine modules 108 and access modules 110 than processing nodes 106. In one example, during operation, the one or more physical processors 105 included in the processing nodes 106 may execute the parsing engine modules 108 and access modules 110 by switching between the executions of the various modules at a rapid rate allowing the vprocs to substantially operate in “parallel.”

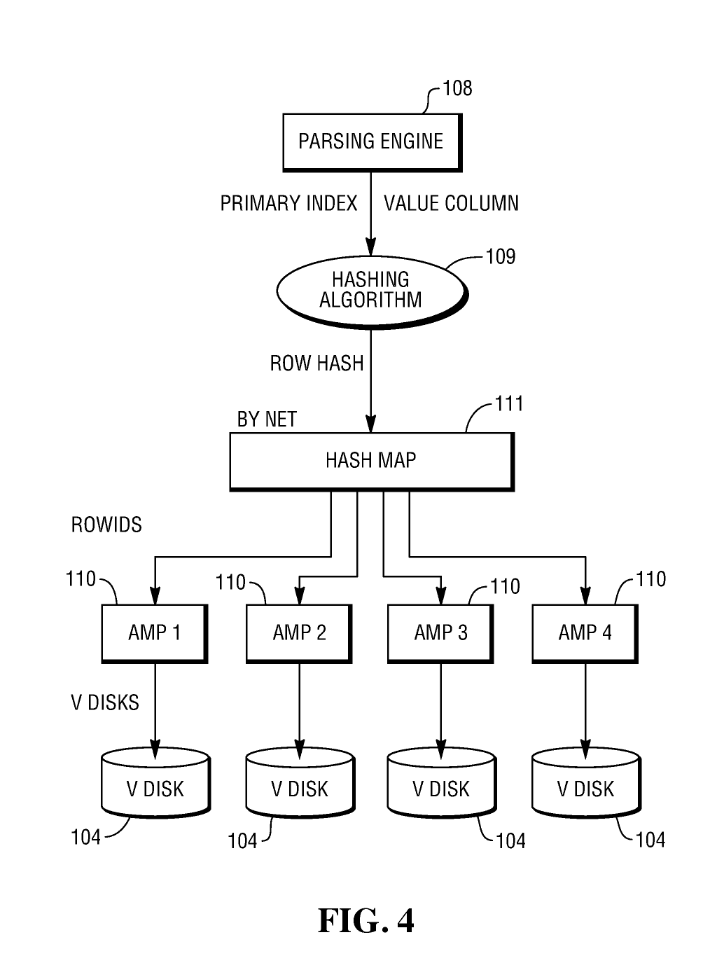

The RBDMS 102 stores data in one or more tables in the DSFs 104. In one example, rows 115 of a table, “Table 1,” are distributed across the DSFs 104 and in accordance with their primary indexes. The primary index distributes the records in a table across the AMPs, by hashing the columns that make up the primary index to determine which records go to which AMP. FIG. 4 provides an illustration of this hashing process. A hashing algorithm 109 produces hash values from the values in the columns specified by the primary index. Some portion, possibly the entirety, of the hash value is designated a “hash bucket.” The hash buckets are assigned to DSFs 104 and associated access modules 110 by a hash bucket map 111. The characteristics of the columns chosen for the primary index determine how evenly the rows are distributed.

Rows of each stored table may be stored across multiple DSFs 104. Each parsing engine module 108 may organize the storage of data and the distribution of table rows. The parsing engine modules 108 may also coordinate the retrieval of data from the DSFs 104 in response to queries received, such as those received from a client computer system 114 connected to the RBDMS 102 through connection with a network 116. The network 116 may be wired, wireless, or some combination thereof. The network 116 may be a virtual private network, web-based, directly-connected, or some other suitable network configuration. In one example, the client computer system 114 may run a dynamic workload manager (DWM) client 118. Alternatively, the database system 100 may include a mainframe 119 used to interact with the RBDMS 102.

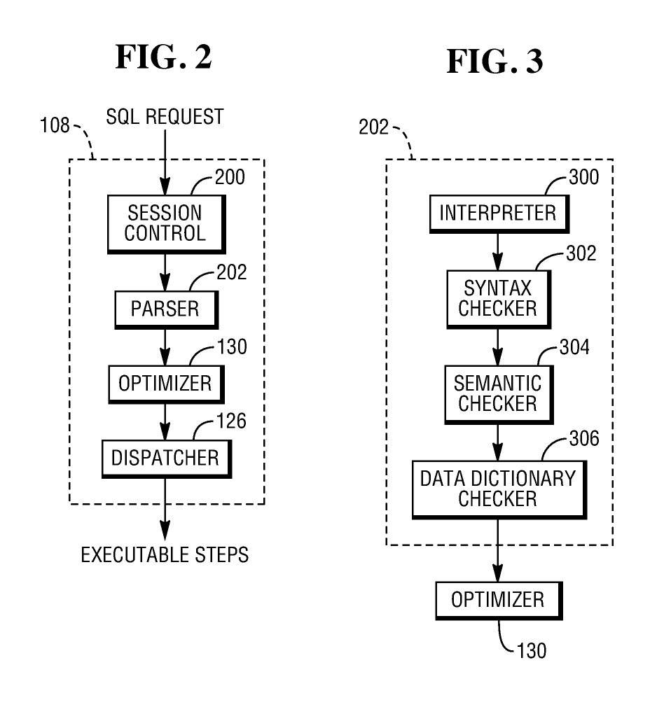

Each parsing engine module 108, upon receiving an incoming database query, such as the query 130, may apply an optimizer module 120 to assess the best plan for execution of the query. An example of an optimizer module 120 is shown in FIG. 1 with regard to parsing engine module 108. Additional description of the parsing engine modules 108 is provided in with regard to FIGS. 2 and 3. Selecting the optimal query-execution plan may include, among other things, identifying which of the processing nodes 106 are involved in executing the query and which database tables are involved in the query, as well as choosing which data-manipulation techniques will serve best in satisfying the conditions of the query. To this end, for each parsing engine module 108, a parser module 202 (see FIG. 2), and/or optimizer module 120 may access a data dictionary module 122, shown in FIG. 1 specifically for parsing engine module 108 for purposes of illustration.

The data dictionary module 122 may specify the organization, contents, and conventions of one or more databases, such as the names and descriptions of various tables maintained by the RBDMS 102 as well as fields of each database, for example. Further, the data dictionary module 122 may specify the type, length, and/or other various characteristics of the stored tables. The RBDMS 102 typically receives queries in a standard format, such as the structured query language (SQL) put forth by the American National Standards Institute (ANSI). However, other formats, such as contextual query language (CQL), data mining extensions (DMX), and multidimensional expressions (MDX), for example, may be implemented in the database system 100 separately or in conjunction with SQL. The data dictionary may be stored in the DSFs 104 or some other storage device and selectively accessed.

The RBDMS 102 may include an active system management (ASM) module 124. The ASM module 124 may be implemented as a “closed-loop” system management (CLSM) architecture capable of satisfying a set of workload-specific goals. In other words, the RBDMS 102 is a goal-oriented workload management system capable of supporting complex workloads and capable of self-adjusting to various types of workloads. The ASM module 124 may communicate with each optimizer module 120, as shown in FIG. 1, and is adapted to convey a confidence threshold parameter and associated parameters to the optimizer module 120 in communication. Further, the ASM module 124 may communicate with a dispatcher module 126 of each parsing engine module 108 (as shown in detail FIG. 1 for parsing engine module 108) to receive query execution plan costs therefrom, and to facilitate query exception monitoring and automated modifications of confidence threshold parameters in accordance with disclosed embodiments. Further, the DWM client 118 may communicate with the ASM module 124 via the network 116.

The ASM module 124 operation has four major phases: 1) assigning a set of incoming request characteristics to workload groups, assigning the workload groups to priority classes, and assigning goals (referred to as Service Level Goals or SLGs) to the workload groups; 2) monitoring the execution of the workload groups against their goals; 3) regulating (e.g., adjusting and managing) the workload flow and priorities to achieve the SLGs; and 4) correlating the results of the workload and taking action to improve performance. In accordance with disclosed embodiments, the ASM module 124 is adapted to facilitate control of the optimizer module 120 pursuit of robustness with regard to workloads or queries.

An interconnection 128 allows communication to occur within and between each processing node 106. For example, implementation of the interconnection 128 provides media within and between each processing node 106 allowing communication among the various processing units. Such communication among the processing units may include communication between parsing engine modules 108 associated with the same or different processing nodes 106, as well as communication between the parsing engine modules 108 and the access modules 110 associated with the same or different processing nodes 106. Through the interconnection 128, the access modules 110 may also communicate with one another within the same associated processing node 106 or other processing nodes 106.

The interconnection 128 may be hardware, software, or some combination thereof. In instances of at least a partial-hardware implementation the interconnection 128, the hardware may exist separately from any hardware (e.g., processors, memory, physical wires, etc.) included in the processing nodes 106 or may use hardware common to the processing nodes 106. In instances of at least a partial-software implementation of the interconnection 128, the software may be stored and executed on one or more of the memories 107 and processors 105 of the processor nodes 106 or may be stored and executed on separate memories and processors that are in communication with the processor nodes 106. In one example, interconnection 128 may include multi-channel media such that if one channel ceases to properly function, another channel may be used. Additionally, or alternatively, more than one channel may also allow distributed communication to reduce the possibility of an undesired level of communication congestion among processing nodes 106.

In one example system, each parsing engine module 108 includes three primary components: a session control module 200, a parser module 202, and a dispatcher module 126 as shown in FIG. 2. The session control module 200 provides the logon and logoff functions. It accepts a request for authorization to access the database, verifies it, and then either allows or disallows the access. Once the session control module 200 allows a session to begin, an SQL request may be received such as through submission by a user and the SQL request is routed to the parser module 202.

As illustrated in FIG. 3, the parser module 202 may include an interpreter module 300 that interprets the SQL request. The parser module 202 may also include a syntax checker module 302 that checks the request for correct SQL syntax, as well as a semantic checker module 304 that evaluates the request semantically. The parser module 202 may additionally include a data dictionary checker 306 to ensure that all of the objects specified in the SQL request exist and that the user has the authority to perform the request. The parsing engine module 108 implements the optimizer module 120 to select the least expensive plan to perform the request, and the dispatcher 126 coordinates the runtime execution of executable steps of the query execution plan of the optimizer module 120 with the access modules 110.

What is required to enable time series data to be stored in a distributed Relational Database is a means by which the time continuum can be broken into a series of consecutive time segments. Each of these segments are assigned a simple integer identifier, which increases with time. Each time series record is then assigned its corresponding time segment number, based on which segment the time series falls relative to its embedded time stamp. The distribution idea is then to store all time series records, bearing the same time segment number, on the same processing/storage unit, and additionally to store those records at their destination in time-order. Because the context necessary to map time series records to a time segment number is stored in the dictionary, this gives the Distributed Relational Database Optimizer all the information it requires to understand/determine where specific time records are to be stored, as well as an understanding relative to retrieving the data.

The solution described herein introduces the concept of an object oriented primary index, which can be used to organize/transform a time series into a series of sequentially labelled time segments, each of which are stored within the relational database in a time-sequence order, and a PRIMARY TIME INDEX clause, that enables the Primary Index to go beyond being a purely scalar index, but rather being a primary index based on ‘objects,’ e.g., time segments, or both time segments and scalars.

A user can create a Time Series table by submitting a CREATE TABLE statement containing a PRIMARY TIME INDEX clause. The created Time Series table is always a MULTISET table, but is permitted to be: permanent, global temporary, or volatile. The PRIMARY TIME INDEX clause contains all information needed to create a time series primary index.

Time Series tables can be sequenced or non-sequenced, the user chooses between these two options via the sequenced_flag parameter within the PRIMARY TIME INDEX clause. The distinction between a non-sequenced and sequenced Time Series table is with regards to how rows are physically stored within the Time Series table, and how rows are sorted prior to engaging in a Time Series Query operation. For Time Series non-sequenced tables, which are designated by setting the PRIMARY TIME INDEX <sequenced_flag> parameter to a value of “NONSEQUENCED”, Teradata physically stores rows in time-ascending order, based on the value of the TD_TIMECODE field in the row.

For Time Series sequenced tables, which are designated by setting the PRIMARY TIME INDEX <sequenced_flag> parameter to a value of “SEQUENCED”, rows are stored physically in ascending order, based firstly on the value of the TD_TIMECODE field in the row, and secondly based on the value of the TD_SEQNO field. If a Time Series table has been specified as being a SEQUENCED table, then the fields TD_TIMECODE and TD_SEQNO must be collectively distinct. If by their collective values they are determined by the database to be duplicates of another row already inserted into the table, then a SQL user error will be returned to the user.

If the PRIMARY TIME INDEX <sequenced_flag> is not present in the specification, the default state is NONSEQUENCED.

The major syntactical elements that are newly introduced with the time series CREATE TABLE statement and PRIMARY TIME INDEX clause are described below:

For a Time Series Non-sequenced table, sequenced_flag=“NONSEQUENCED” :Note that the only difference between the syntax block below and the syntax block for a sequenced table that follows, is the absence of the Teradata generated SeqNo column.

<create table> ::= CREATE [MULTISET] [GLOBAL TEMPORARY |
VOLATILE ] TABLE <series_table_name> <comma> <table options>
<left paren>

[TD_TIMEBUCKET BIGINT NOT NULL GENERATED SYSTEM
TIMECOLUMN, TD_TIMECODE <timecode_dt> NOT NULL
GENERATED TIMECOLUMN,] <column definitions>

<right paren>
PRIMARY TIME INDEX <optional_index_name>
<left paren> <timecode_dt>, [, <timezero_date>]
[,<timebucket_duration>] [, <columns_clause,>
[, <sequenced_flag> ]
<right paren>
[ <as clause> ] [ <index definitions> ] [ <commit options> ] ;
<timecode_dt> ::= {TIMESTAMP | TIMESTAMP WITH TIME ZONE |

DATE}

<timezero_date> ::= A DATE value specifying the “time zero” associated

with the table.

<timebucket_duration> ::= A time duration that can be specified using an

abbreviation.

<columns_clause> ::= COLUMNS <left-paren> <column_list> <right
paren>
<column_list> :: <column_name> [ <comma> <column_name> ... ]
<column_name> ::= !!Teradata name label, aka, <identifier>
<sequenced_flag> :: { SEQUENCED | NONSEQUENCED }
<index definitions> ::= INDEX [<index name>] <left paren> <index

column name> <right paren>;

<index name> ::= <identifier>
<index column name> ::= <identifier>

For a Time Series Sequenced table, sequenced_flag=“SEQUENCED”:

<create table> ::= CREATE [MULTISET] [GLOBAL TEMPORARY |
VOLATILE] TABLE <series_table_name> <comma> <table options>
<left paren>

[ TD_TIMEBUCKET BIGINT NOT NULL GENERATED
SYSTEM TIMECOLUMN, TD_TIMECODE <timecode_dt> NOT
NULL GENERATED TIMECOLUMN, TD_SEQNO INT NOT
NULL GENERATED TIMECOLUMN [MAXIMUM = seq no],
]<column definitions>

<right paren>
PRIMARY TIME INDEX <optional_index name >
<left paren> <timecode_dt>, [, <timezero_date>]
[,<timebucket_duration>] [, <columns_clause,>]
[, <sequenced_flag> ]
<right paren>
[ <as clause> ] [ <index definitions> ] [ <commit options> ] ;
<optinal_index name> : < identifier associated with the index >

Time Series Table Columns

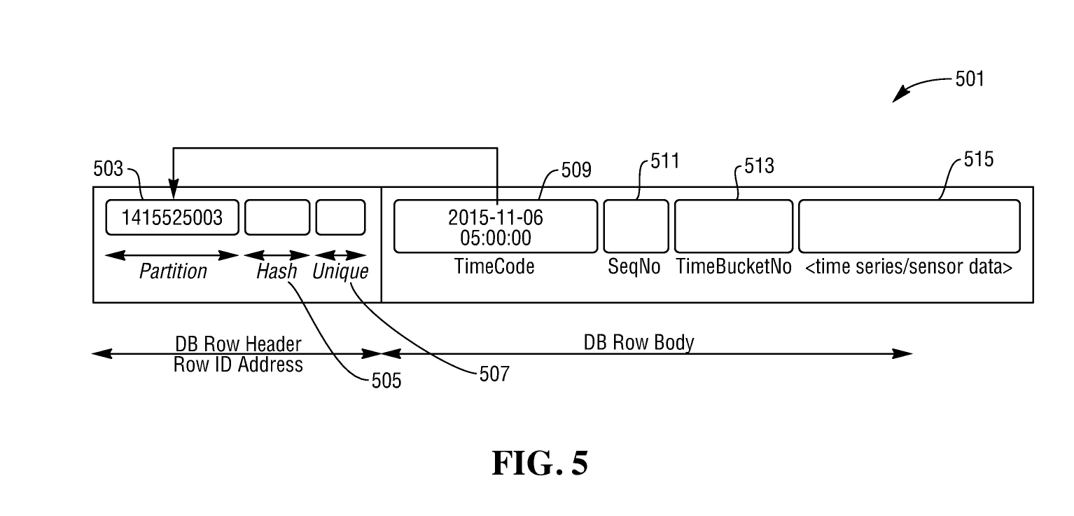

FIG. 5 provides an illustration of an example database table row header and row body for a time series table. The row header, including partition 503, hash 505, and unique ID 507 fields identify where and in what order rows are stored within tables. A time series table will also contain the generated TD_TIMEBUCKET 509 and TD_TIMECODE 511 columns. If the PRIMARY TIME INDEX clause has the sequenced_flag parameter set to SEQUENCED, then the Time Series table will additionally include the generated TD_SEQNO 513 column. Data is stored in fields 515. A mapping between the TD_TIMECODE 511 and partition fields permits an ordering of rows by TD_TIMECODE.

The TD_TIMEBUCKET column is classified as being a GENERATED SYSTEM TIMECOLUMN. The data type associated with this column is always of type BIGINT. This column specification is implicitly generated as part of the CREATE TABLE operation, and is later populated and managed by the database administrator. It is essentially invisible to the user in that it is invisible to INSERT statements, and cannot be UPDATED, directly SELECTED, or otherwise be present in any database expression.

The TD_TIMECODE column is classified as being a GENERATED TIMECOLUMN. The data type that is associated with this column is specified by user via the <timecode_dt> parameter that lies within the PRIMARY TIME INDEX clause. This column specification is implicitly generated as part of the CREATE TABLE operation. The column is specified as being NOT NULLABLE, thus a value must always be provided by the user, when later loading data by INSERTs or other means. The column is user visible, meaning the user may reference within a Teradata expression, and thus may perform UPDATEs or SELECTs against it.

If the user decides to explicitly enter the TD_TIMECODE column specification as part of the CREATE TABLE, then the TD_TIMECODE column must be in the following format:

TD_TIMECODE <timecode_dt> NOT NULL GENERATED
TIMECOLUMN
TD_TIMECODE <timecode_dt> NOT NULL GENERATED

TIMECOLUMN FORMAT <quote_string>

TD_TIMECODE <timecode_dt> NOT NULL GENERATED

TIMECOLUMN TITLE <quote_string>

TD_TIMECODE <timecode_dt> NOT NULL GENERATED

TIMECOLUMN FORMAT <quote_string> TITLE <quote_string>

TD_TIMECODE <timecode_dt> NOT NULL GENERATED

TIMECOLUMN TITLE <quote_string> FORMAT <quote_string>

TD_TIMECODE

The value entered for <timecode_dt> must match exactly as the same named parameter in PRIMARY TIME INDEX clause.

The TD_SEQNO column is classified as being a GENERATED TIMECOLUMN. This column specification is implicitly generated as part of the CREATE TABLE operation whenever the SEQUENCED flag is present within the PRIMARY TIME INDEX clause. The column is specified as being NOT NULLABLE, thus a value must always be provided by the user, when later loading data by INSERTs or other means. The column is user visible, meaning the user may reference within a Teradata expression, and thus may perform UPDATEs or SELECTs against it.

If the user decides to explicitly enter the TD_SEQNO column specification as part of the CREATE TABLE, then the TD_SEQNO column must be in the following format:

TD_SEQNO INT NOT NULL GENERATED TIMECOLUMN

[MAXIMUM = seq no]

TD_SEQNO INT NOT NULL GENERATED TIMECOLUMN

[MAXIMUM = seqno] FORMAT <quote_string>

TD_SEQNO INT NOT NULL GENERATED TIMECOLUMN

[MAXIMUM = seqno] TITLE <quote_string>

TD_SEQNO INT NOT NULL GENERATED TIMECOLUMN

[MAXIMUM = seqno] FORMAT <quote_string> TITLE
<quote_string>

TD_SEQNO INT NOT NULL GENERATED TIMECOLUMN

[MAXIMUM = seqno] TITLE <quote_string> FORMAT

<quote_string>

Where the valid range of seq_no is between 1 to 2147483647 inclusively. If the optional MAXIMUM clause is not specified, the default seq_no is 20,000. TD_SEQNO

PRIMARY TIME INDEX Clause

The PRIMARY TIME INDEX clause utilizes up to five potential parameters: <timecode_dt>, <timezero_date>, <timebucket_duration>, <columns_clause>, and <sequenced_flag>.

The <timecode_dt> parameter specifies the data type that is associated with the generated TD_TIMECODE column. The user can choose between TIMESTAMP, TIMESTAMP WITH TIME ZONE, or DATE.

The <sequenced_flag> is set to SEQUENCED to indicate that this is to be a Sequenced Time Series table. It is set to NONSEQUENCED to indicate that this is to be a Non-sequenced Time Series table. Entering this parameter is optional. If not present, the default is NONSEQUENCED.

The PRIMARY TIME INDEX can have a name associated with it just like other index. This name should be specified as part of the CREATE TABLE statement.

There are three parameters, which influence how time series rows are distributed: the <timezero_date>, <timebucket_duration>, and <columns_clause> parameters. The user can chose from three different time series distribution strategies, based on the entries for these parameters.

Strategy A: Distribute the time series solely on the basis of the Time Bucket parameters—<timezero_data> and <timebucket_duration>. Example: PRIMARY TIME INDEX(TIMESTAMP(6), DATE ‘04-19-2016’, HOURS(1))

Strategy B: Distribute the time series on the joint basis of the Time Bucket parameters and the contents of the <columns clause>. Example: PRIMARY TIME INDEX(TIMESTAMP(6), DATE ‘04-19-2016’, HOURS(1), COLUMNS (BUOYID))

Strategy C: Distribute the time series solely on the basis of the <columns_clause>. In this case, TD_TIMEBUCKET column is not present. Example: PRIMARY TIME INDEX(TIMESTAMP(6), DATE ‘04-19-2016’,TD_TIMEBUCKET COLUMNS(SEISMIC_TRACE_ID))

Strategy A: Time Bucket Parameter Based Distribution

If only the time bucket specific parameters are present (either explicitly or implicitly)—<time_zero> and <timebucket_duration>; then time series rows will be distributed solely on the basis of these two parameters. These two parameters will be used to calculate a TD_TIMEBUCKET value, which is then transparently written into the time series TD_TIMEBUCKET column. Thereafter, rows are distributed in the same manner as if the clause “PRIMARY INDEX (TD_TIMEBUCKET)” had been entered, i.e., the hash of the value is computed and the hash value is used to determine the appropriate AMP to map to.

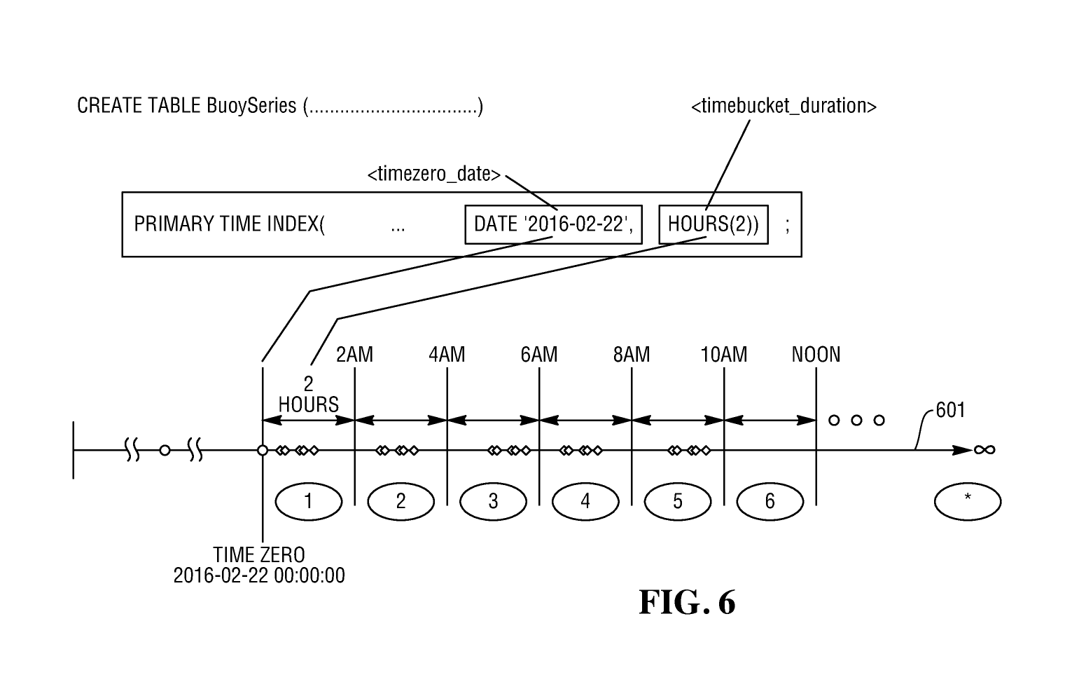

To understand better the role of the <timezero_date> and <timebucket_duration> parameters, consider FIG. 6 and the explanation that follows.

FIG. 6 illustrates how the <timezero_date> and <timebucket_duration> are used to divide the time continuum 601 into a collection of consecutive time segments. In FIG. 5 the time continuum 601, beginning at “time zero”, e.g., 2016-02-22 00:00:00, is divided into a collection of consecutive time segments of size 2 hours. These time segments, labeled 1, 2, 3, 4, 5, 6, etc., are also referred to as “time buckets.” Once the time continuum has been divided, a simple integral numbering scheme is applied to label all the time buckets. Rows inserted into the table having a TD_TIMECODE value, or “time point,” falling within a particular time segment/time bucket, will be assigned the same time bucket number. This calculated number is then transparently assigned to the TD_TIMEBUCKET field value of the row.

The <timezero_date> parameter sets the “time zero” time point that is associated with this Time Series table. The date value that this parameter is set to must be a date that precedes the TD_TIMECODE values associated with any rows inserted into this table. If an attempt is made to insert a row having a TD_TIMECODE value lesser than the time zero date value, then a SQL error will be returned to the user. Note that entering this parameter value is optional. If not present, then the <timezero_date> value will be set to EPOCH time, Jan. 1^{st}, 1970@00:00:00 hours. The Time Zero value is internally interpreted to be in UTC time zone by default, but as in case of timestamp with time zone columns, this can controlled by the TimeDateWZControl DBS Control field which can specify that DateTime values without time zone information be stored in the database as system local time. If the user decides to explicitly enter the <timezero_date> as part of the CREATE TABLE statement, then <timezero_date> must have the following format: DATE ‘YYYY-MM-DD’. If a user does not specify this parameter when creating the table, then the <timezero_date> parameter will be assigned a default value equal to EPOCH time: DATE ‘1970-01-01’.

The <timebucket duration> sets the width of the time segment, which will be used to divide the time continuum into an identifiable collection of serial time segments or time buckets. Entering this parameter value is optional. If not present, then the <column list> has to be present, which would make this table hash on the column list. An error will be returned if both <timebucket_duration> and <column_list> are not present.

If the user decides to explicitly enter the <timebucket_duration> as part of the CREATE TABLE, then the user can utilize any of several abbreviations to assign a value to the <timebucket_duration> parameter. If the user does not explicitly specify this parameter value, then <timebucket_duration> parameter will be assigned a default value of: DAYS(1).

Strategy B: Time Bucket Parameter and Column-clause Based Distribution

If both the time bucket parameters: <timezero_date> and <timebucket_duration>; and the <columns_clause> are present, then the database system first calculates a time bucket value (transparently writing it into the TD_TIMEBUCKET column), and distributes the row in the same manner as if the clause “PRIMARY INDEX(TD_TIMEBUCKET, <columns list>))” had been entered, meaning it computes the joint hash-value associated with the series of column values and uses that hash value to determine the appropriate AMP to map to. Examples:
PRIMARY TIME INDEX (TIMESTAMP(6), DATE ‘04-19-2016’, MINUTES(30), COLUMNS(BUOYID))
PRIMARY TIME INDEX (TIMESTAMP(6), DATE ‘04-19-2016’, HOURS(2), COLUMNS(COUNTRYID, BMWID))
PRIMARY TIME INDEX (TIMESTAMP(3), DATE ‘04-19-2016’, 30s, COLUMNS(AIRBEACONID))

Entering the <columns clause> parameter value is optional. If not present, then the database system assumes that the user wishes to distribute the time series rows solely on the basis of the hash of the TD_TIMEBUCKET value, effectively distributing the rows on the basis of: “PRIMARY INDEX(TD_TIMEBUCKET)”.

Strategy C: Columns-clause Based Distribution

If there is no TD_TIMEBUCKET value then rows are effectively distributed to the time series table in the same mariner as if the clause “PRIMARY INDEX(<columns list>))” had been typed in, meaning the hash-value associated with the series of <columns list> values is computed and then used to determine the appropriate AMP to map to. Examples:
PRIMARY TIME INDEX (TIMESTAMP(6), DATE ‘01-01-2016’, TD_TIMEBUCKETCOLUMNS(SEISMICTRACEID))
PRIMARY TIME INDEX (TIMESTAMP(6), DATE ‘01-01-2016’, TD_TIMEBUCKETCOLUMNS(SHOTID, RECEIVERID, TRACEID)

The table shown below summarizes the three distribution storage options and PRIMARY TIME INDEX clause parameter requirements discussed above:

| | TS Data | Time | Time | Column |
|---|---|---|---|---|
| Storage Option | Type | Zero | Bucket | list |
| Option A | Required | Optional | Required | Absent |
| (hash by Timecode only) | | | | |
| Option B | Required | Optional | Required | Present |
| (hash by Timecode and | | | | |
| column list) | | | | |
| Option C | Required | Optional | Absent | Present |
| (hash by column list only) | | | | |

The techniques described above and illustrated in the accompanying figures provide for the creation of a primary index and associated time series table for the organization of a time series data set by time, while simultaneously storing the dataset in an easily queryable time sequential manner

The foregoing description of the invention has been presented for purposes of illustration and description. It is not intended to be exhaustive or to limit the invention to the precise form disclosed.

Additional alternatives, modifications, and variations will be apparent to those skilled in the art in light of the above teaching. Accordingly, this invention is intended to embrace all alternatives, modifications, equivalents, and variations that fall within the spirit and broad scope of the attached claims.

What is claimed is:

1. A method for storing time series data in a distributed relational database, the method comprising the steps of:
establishing, by a processor, a database table including a time code field and a time segment field;
defining, by said processor, a series of consecutive numbered time segments;
receiving, by said processor, a database record including data and an associated timestamp;
selecting, by said processor, a time segment number corresponding to said timestamp; and
saving, by said processor, said database record including said data, a time code value corresponding to said timestamp, and said time segment number to said database table, whereby said record is saved in said database table in a time ordered manner

2. The method for storing time series data in a distributed relational database in accordance with claim 1, wherein:
said database table is established by a create table statement including a time zero value and a time segment size; and
said series of consecutive numbered time segments begin with said time zero value, and said time segments have the time segment size.

3. The method for storing time series data in a distributed relational database in accordance with claim 1, wherein:
said a database table including a row ID address field; and
said method further includes the step of selecting a row ID address value for said record corresponding to said timestamp.

4. A method for storing time series data in a distributed relational database, the method comprising the steps of:
establishing, by a processor, a database table including a row ID address field, a time code field, and time segment field;
receiving, by said processor, a database record including data and an associated timestamp value;
selecting, by said processor, a row ID address value for said record corresponding to said timestamp value; and
saving, by said processor, said database record including said data and said row ID address value to said database table, whereby said record is saved in said database table in a time ordered manner.

5. A system comprising:
a distributed relational database; and
a processor for:
creating a database table including a time code field and a time segment field;
defining a series of consecutive numbered time segments;
receiving a database record including data and an associated timestamp;
selecting a time segment number corresponding to said timestamp; and
saving said database record including said data, a time code value corresponding to said timestamp, and said time segment number to said database table, whereby said record is saved in said database table in a time ordered manner.

6. The system in accordance with claim 5, wherein:
said database table is created in response to a create table statement including a time zero value and a time segment size; and
said series of consecutive numbered time segments begin with said time zero value, and said time segments have the time segment size.

7. The system in accordance with claim 5, wherein:
said a database table includes a row ID address field; and
said processor selects a row ID address value for said record corresponding to said timestamp.

8. A system comprising:
a distributed relational database; and
a processor for:
creating a database table including a row ID address field, a time code field, and time segment field;
receiving a database record including data and an associated timestamp;
selecting a row ID address value for said record corresponding to said timestamp; and
saving said database record including said data and said row ID address value to said database table, whereby said record is saved in said database table in a time ordered manner
